(19) United States
(12) Patent Application Publication
(10) Pub. No.: US 2006/0187745 A1
(43) Pub. Date: Aug. 24, 2006

(54) Culinary whisk

(76) Inventor: Kwok Onn Fung, ShaPing Town (CN)

Correspondence Address: OSTROLENK FABER GERB & SOFFEN, 1180 AVENUE OF THE AMERICAS, NEW YORK, NY, 100368403, US

(21) Appl. No.: 11/348,192

(22) Filed: Feb. 6, 2006

(30) Foreign Application Priority Data
Feb. 23, 2005 (GB) 0503757.7

(51) Int. Cl. A47J 43/10

(52) U.S. Cl. 366/129

(57) ABSTRACT

A culinary whisk comprising a handle, a plurality of wire loops extending from the handle defining a balloon-shaped utility portion and an internal body disposed within the utility portion formed integrally with or connected to the plurality of wire loops.

### FIELD OF INVENTION

The present invention is concerned with an improved culinary whisk.

### BACKGROUND OF THE INVENTION

There are a variety of culinary whisks, the most common type being a so-called balloon whisk comprising a handle connected to a number of wire loops. In order to enhance the whisking efficiency, it is desirable to form such with a large number of wire loops. However, this would increase the manufacture cost and these whisks are often difficult to clean after use due to increased number of wires. For this reason, it has been proposed to introduce an independent object within the wire loops, which as the whisk is moved backward and forward can move independently and increase the efficiency of beating. Such whisks are shown in FIGS. 1 and 2. FIG. 1 shows a whisk 1 having an elongate handle portion 2 and a utility portion 4 formed of a plurality of wire loops 6. A spherical plastics object 8 having a number of relatively large openings 10 is provided. FIG. 2 similarly shows a whisk 12 having an object 14 formed of wires within a utility portion 16. However, such whisks 1, 12 still are unsatisfactory particularly due to increased cost of production of the additional independent component (the round-shaped object 8, 14).

The present invention is directed to address the above problems, to provide an improved whisk or at least to provide an alternative to the public.

### SUMMARY OF THE INVENTION

According to the present invention, there is provided a culinary whisk comprising a handle, a plurality of wire loops extending from the handle defining a balloon-shaped utility portion and an internal body disposed within the utility portion formed integrally with or connected to the plurality of wire loops. The wire loops may preferably be made of stainless steel although other inert materials suitable for making cooking utensils may also be used.

Preferably, the internal body may be of a generally spherical shape, although other suitable shapes such an egg shape would equally work. Spherical-shaped internal bodies can enhance the whisking efficiency.

Suitably, the internal body may be constituted of portions or parts of the loops defining a three-dimensional body. In particular, the internal body may be constituted by a separate member fixedly secured with the utility portion. In this case, the separate member may also be made of stainless steel. Alternatively, the separate member may be made of plastics. In either case, the separate member may be connected to the utility portion with a small wire loop or a ring binding them together. The internal body may be arranged at an end of the utility portion away from the handle to enhance the whisking efficiency.

Advantageously, the utility portion may be formed of six or seven wire loops. These numbers of wire loops are suitable for most handheld culinary whisks. If there were too many wire loops (e.g. 12), foodstuffs to mixed would be difficult to enter into and exit out of the utility portion and thus the whisking efficiency might be comprimised. If there were not enough wire loops then the whisk would not be able to mix the foodstuffs effectively.

Preferably, the utility portion may comprise a neck region adjacent to the handle, and the neck region may generally be cylindrical in shape with a width or diameter comparable to or slightly smaller than that of the handle. Alternatively, the utility portion may also be provided with a middle region generally arranged between the neck region and the internal body yet alternatively, the utility portion may be provided with a middle region arranged adjacent to the neck region, the middle region having a width substantially larger than that of the neck region or comparable to that of the internal body. The middle region may be arranged between the neck region of the handle and a front enlarged region of the utility portion. The provision of the wider middle region in addition to the front enlarged region in the utility portion may be particularly suitable for whisking in a relatively large and deep container filled with foodstuffs in that a greater portion of the utility portion is immersed in the foodstuffs. The wider middle region facilitate the mixing of the foodstuffs.

Suitably, the internal body may be constituted by a separate member fixedly secured with the utility portion. The separate member may be made of plastics. The internal body may be arranged at an end of the utility portion away from the handle.

### BRIEF DESCRIPTION OF THE DRAWINGS

Embodiments of the present invention are described, by way of example only, with reference to the following drawings in which:

FIG. 1 is a perspective view of a prior art whisk;

FIG. 2 is a perspective view of another prior art whisk;

FIG. 3 is a perspective view of a whisk according to a first embodiment of the present invention;

FIG. 4 is a side view of the whisk in FIG. 3;

FIG. 5 is another side view of the whisk in FIG. 3;

FIG. 6 is a schematic diagram showing one wire loop of the whisk in FIG. 3; and

FIG. 7 is a perspective view of a whisk according to a second embodiment of the present invention.

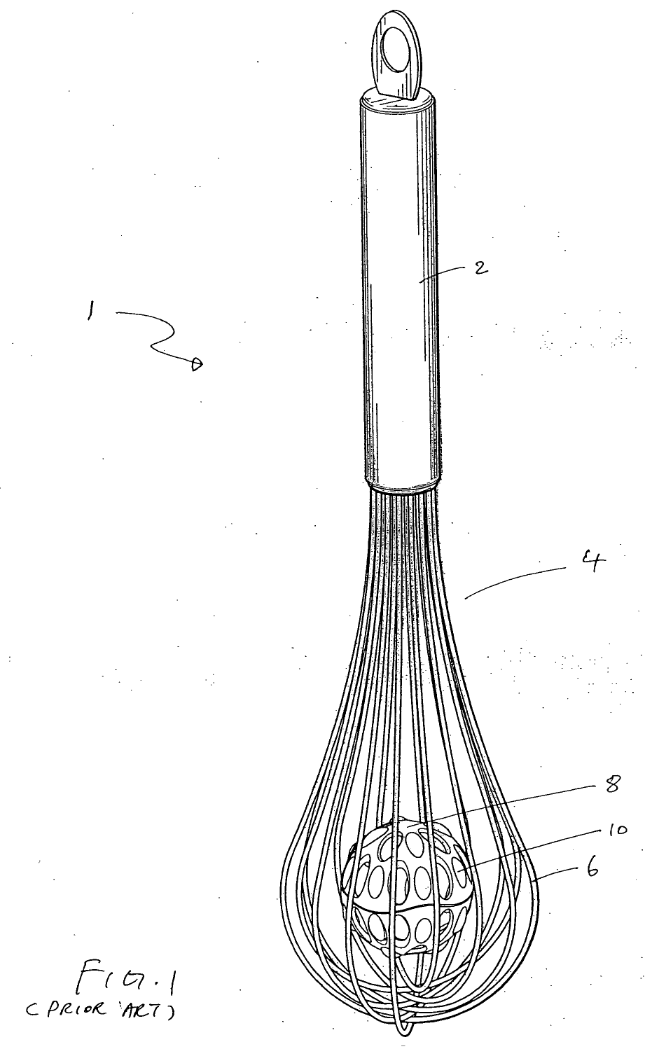

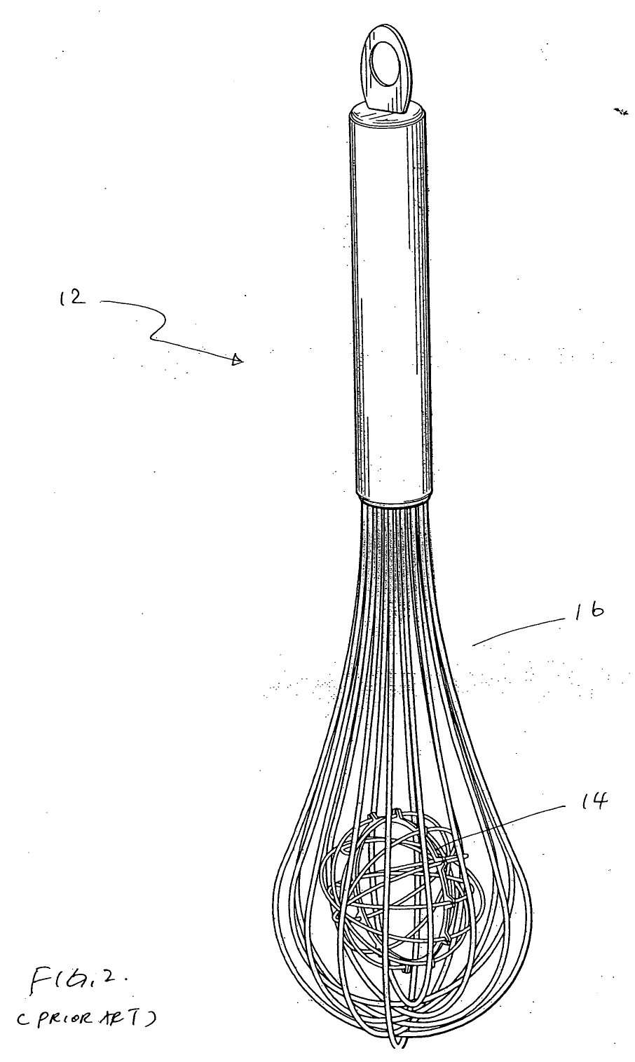

### DETAILED DESCRIPTION OF THE PREFERRED EMBODIMENTS

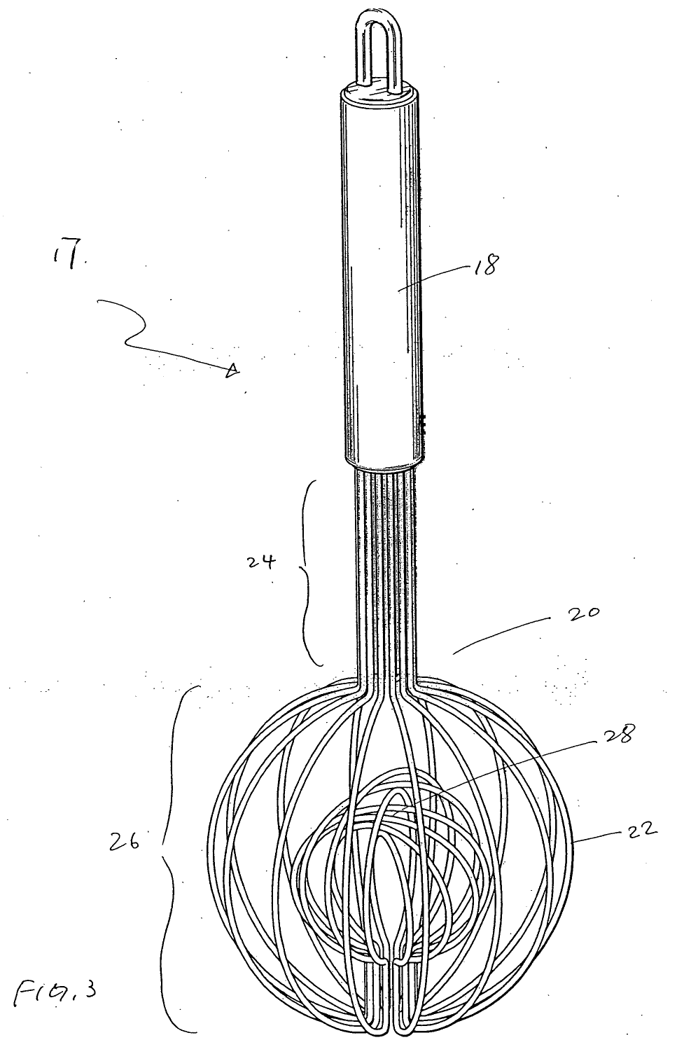

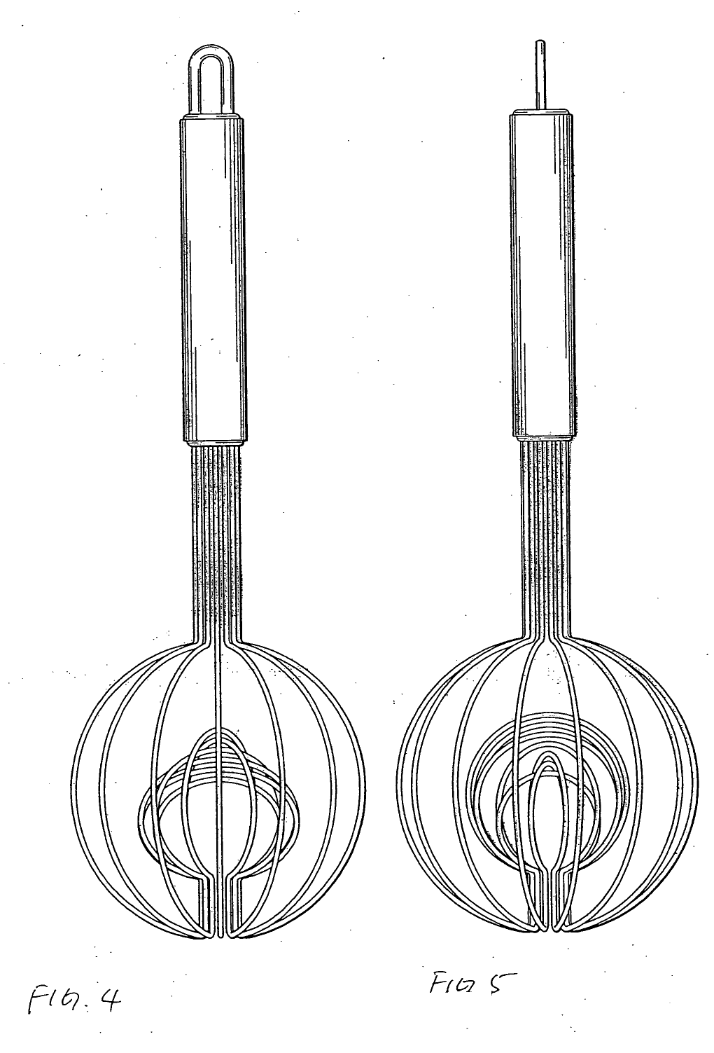

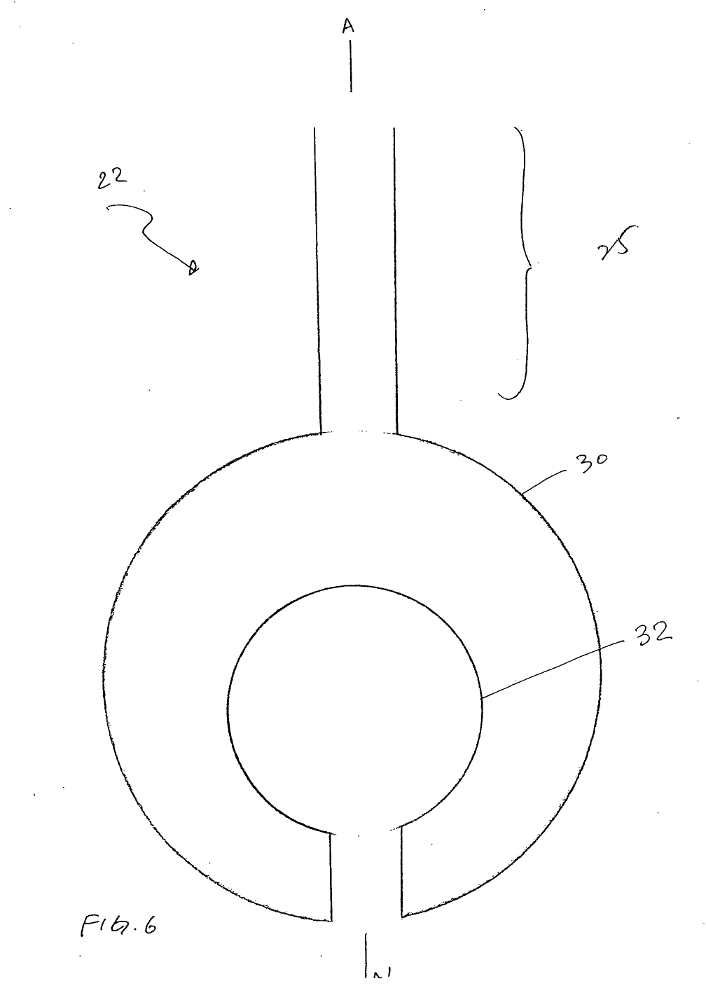

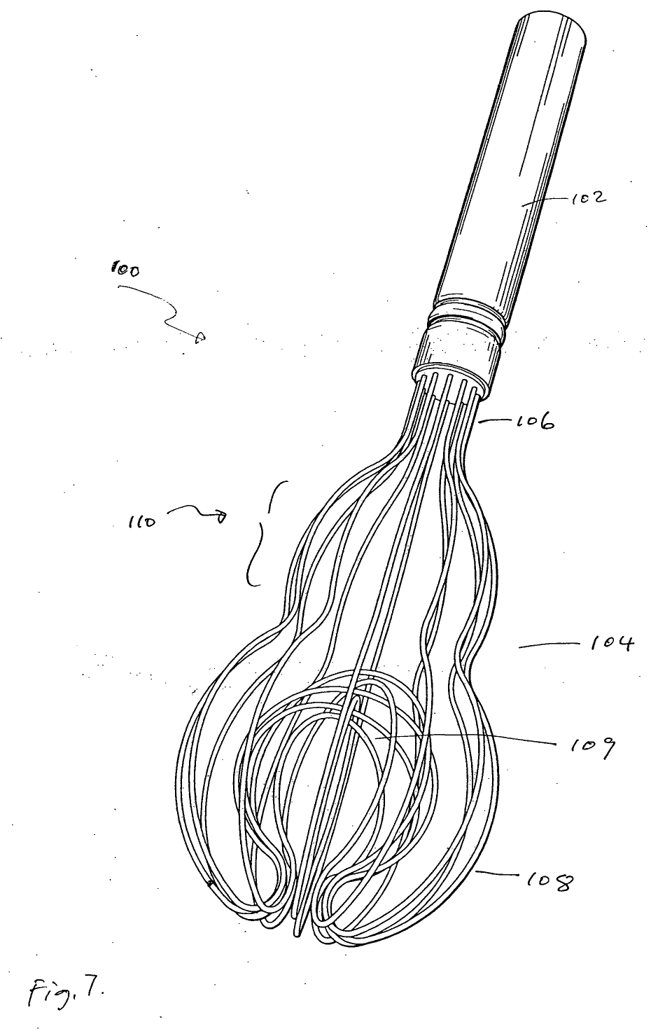

Referring specifically to FIGS. 3 to 5, there is shown a first embodiment of a whisk in accordance with the present invention generally designated as 17. The whisk 17 comprises an elongate handle 18 and a utility portion 20 formed of a plurality of wire loops 22 extending from the handle 18. The utility portion 20 has an elongate region or neck region 24 adjacent the handle and a balloon-shaped region 26 defining a relatively large space therein. The elongate region is generally cylindrical in shape. The upper portion of the wire loops 22 together defines the elongate region 24 and the lower portion of the loops 22 defines the balloon-shaped region 26. The balloon-shaped region 26 is provided with a smaller generally spherical formation or body 28 therein. The formation 28 has a generally similar shape to the balloon-shaped region 26 of the utility portion 20 although it is much smaller. In contrast to the prior designs the spherical formation 28 is formed integrally with the balloon-shaped region 26. In the illustrated embodiment, there are seven wire loops 22 with each loop extending from the handle 18. Each wire loop 22 is roughly in a configuration as shown in FIG. 6 in that it consists of a straight upper region 25, a circular outer loop 30 and a circular but smaller inner loop 32. It is to be noted that while the outer loop 30 of the wire loops 22 has approximately the same size, the inner loops 32 are slightly different in size such that they can overlap and constitute the smaller spherical formation 28. Although as illustrated each wire loop 22 makes only a single inner loop 32, it could alternatively be arranged that each wire loop 22 include a number of inner loops.

A whisk in accordance the present invention is desirable for a number of reasons. First, the number of wires at the lower region of the balloon-shaped region is increased and as such whisking of foodstuffs is enhanced. Second, since the inner formation 28 is integral, it moves together with the outer wire loops, whereby it is easier to control whisking. Third, the inner member is not detachable from the whisk and therefore cannot become lost or present a swallowing hazard to children. Fourth, the entire utility portion is formed by relatively few wire loops (only seven in the illustrated embodiment) and as such the manufacture cost is relatively low. Finally, due to the use of relatively few wire loops, cleaning thereof after use is relatively easy.

It is however envisaged that a number of minor modifications can be made to the present invention. For example, the inner member can be made as a separate component made of wires or alternatively a plastics component which is fixedly secured within or connected the utility portion of the whisk. The connection may be achieved by simply having a small wire loop or a ring connecting the component to the utility portion. Alternatively, the component may be snap-fitted to the utility portion. An inner member with a different shape and/or configuration may also be used to suit a particular whisking need. Further, the shape of the utility portion may be modified, as shown in FIG. 7, to be explained as follows.

FIG. 7 shows a second embodiment of a whisk 100 in accordance with the present invention. The whisk 100 in this embodiment is generally similar to the whisk 17 in the first embodiment in that the whisk 100 also comprises a handle 102 and a utility portion 104 having a neck region 106, a balloon-shaped region 108 arranged at the front, and an internal body 109. It is however to be noted that the neck region 106 in this embodiment is relatively short leaving room for the provision of a middle region 110 in the utility portion 104. The middle region 110 is arranged between the neck region 106 and the balloon-shaped region 108 or the internal body, and is wider than the neck region 106 but narrower than the balloon-shaped region 108 at the front. The middle region 110 is similar in width to the internal body 109. The provision of the wider middle region 110 at least increases the whisking efficiency in some operation. For example, the whisk 100 may be particularly suitable for mixing fluid foodstuffs contained in a container and depth of the foodstuffs is relatively great or the foodstuffs are relatively viscous.

1. A culinary whisk comprising:
a handle:
a plurality of wire loops extending from the handle defining a generally balloon-shaped utility portion: and
an internal body disposed within the utility portion formed integrally with or connected to the plurality of wire loops.

2. A whisk as claimed in claim 1, wherein said internal body is of a generally spherical shape.

3. A whisk as claimed in claim 1, wherein said internal body is constituted of portions of said loops defining a three-dimensional body.

4. A whisk as claimed in claim 1 comprising six or seven said wire loops.

5. A whisk as claimed in claim 1, wherein the utility portion comprises a neck region adjacent to said handle, and wherein the neck region is generally cylindrical in shape with a width or diameter comparable to or slightly smaller than that of said handle.

6. A whisk as claimed in claim 5, wherein the utility portion is provided with a middle region generally arranged between the neck region and said internal body.

7. A whisk as claimed in claim 5, wherein the utility portion is provided with a middle region arranged adjacent to the neck region, the middle region having a width substantially larger than that of the neck region or comparable to that of said internal body.

8. A whisk as claimed in claim 1, wherein said internal body is constituted by a separate member fixedly secured with the utility portion.

9. A whisk as claimed in claim 8, wherein said separate member is made of plastics.

10. A whisk as claimed in claim 1, wherein said internal body is arranged at an end of the utility portion away from said handle.
